(19) United States
(12) Patent Application Publication
(10) Pub. No.: US 2021/0279638 A1
(43) Pub. Date: Sep. 9, 2021

(54) TRAINING APPARATUS AND NON-TRANSITORY COMPUTER READABLE MEDIUM

(71) Applicant: FUJIFILM BUSINESS INNOVATION CORP., Tokyo (JP)

(72) Inventors: Ryuji KANO, Kanagawa (JP); Tomoki TANIGUCHI, Kanagawa (JP); Tomoko OHKUMA, Kanagawa (JP)

(73) Assignee: FUJIFILM BUSINESS INNOVATION CORP., Tokyo (JP)

(21) Appl. No.: 17/008,714

(22) Filed: Sep. 1, 2020

(30) Foreign Application Priority Data
Mar. 6, 2020 (JP) 2020-038858

(51) Int. Cl. G06N 20/00; G06K 9/62

(52) U.S. Cl. CPC G06N 20/00; G06K 9/623; G06N 5/046; G06K 9/6298; G06K 9/6215

(57) ABSTRACT

A training apparatus includes an input unit that inputs multiple pairs of input and output, a processor, and an output unit. The processor is configured to, through execution of a program, generate the pairs of input and output as positive examples, and generate, as negative examples, pairs in which the combinations of input and output are changed. The processor is further configured to train a filter model by using the positive examples and the negative examples, and use the filter model to perform filtering by removing incorrect pairs from the pairs of input and output.

### CROSS-REFERENCE TO RELATED APPLICATIONS

This application is based on and claims priority under 35 USC 119 from Japanese Patent Application No. 2020-038858 filed Mar. 6, 2020.

### BACKGROUND

### (i) Technical Field

The present disclosure relates to a training apparatus and a non-transitory computer readable medium.

### (ii) Related Art

When a model is subjected to machine learning on the basis of supervised data, the accuracy of the supervised data directly influences the accuracy of the model. Thus, consideration is to be given to handling of the supervised data.

Japanese Unexamined Patent Application Publication No. 2018-45559 describes the following technique. The degrees of importance calculated for characteristic candidates included in multiple supervised data components are used to calculate the amounts of information of the supervised data components. From the supervised data components, supervised data components used for machine learning are selected.

Japanese Unexamined Patent Application Publication No. 2019-16025 describes a technique of adding data, which is determined to correspond to pairs of an input value and an output value on the basis of a preset validation rule, to new training data.

To improve the accuracy of machine learning, it is necessary to prepare, in advance, a sufficient amount of supervised data formed of correct input-output pairs (hereinafter referred to as “positive examples”). In a machine learning model (for example, deep learning) which needs a large amount of data, learning is often performed by regarding label data, which may be obtained automatically, as correct input-output pairs (for example, texts and headings of news articles). However, such data has many pieces of noise. The present disclosure enables training of a model which filters out such noise without new supervised data. The present disclosure provides a technique for improving the accuracy of machine learning through the filtering.

### SUMMARY

Aspects of non-limiting embodiments of the present disclosure relate to a technique of training a model, which filters out noise included in data, without preparing new supervised data for filtering.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a training apparatus including an input unit that inputs multiple pairs of input and output, a processor, and an output unit. The processor is configured to, through execution of a program, generate the pairs of input and output as positive examples, and generate, as negative examples, pairs in which the combinations of input and output are changed. The processor is further configured to train a filter model by using the positive examples and the negative examples, and use the filter model to perform filtering by removing incorrect pairs from the pairs of input and output.

### BRIEF DESCRIPTION OF THE DRAWINGS

Exemplary embodiment of the present disclosure will be described in detail based on the following figures, wherein:

FIG. 1 is a configuration block diagram according to an exemplary embodiment;

FIG. 2 is a functional block diagram illustrating a training process according to an exemplary embodiment;

FIG. 3A is a diagram for describing a positive example according to an exemplary embodiment;

FIG. 3B is a diagram for describing negative examples according to an exemplary embodiment;

FIG. 4 is a flowchart of a process according to an exemplary embodiment; and

FIG. 5 is a functional block diagram illustrating a training process according to a modified example.

### DETAILED DESCRIPTION

An exemplary embodiment of the present disclosure will be described below on the basis of the drawings by taking, as an example, training of a summary model which receives a text and which outputs a summary of the text.

### Fundamental Idea

The fundamental idea of the present exemplary embodiment will be described.

Attempts for training a summary model by regarding titles as summaries have been made widely after Rush (Alexander M. Rush, Sumit Chopra, and Jason Weston (2015). A neural attention model for abstractive sentence summarization. EMNLP.) Many of the attempts use news article titles. Other than these, such attempts are applied to texts on various media, such as posts on social media, posts on review sites, and mail titles.

However, a question about whether or not titles are appropriate as supervised data for summaries often arises. Especially, the quality of writing on media, on which the general public may do writing freely, such as social media, review sites, and mail, is not ensured. The fact that there are many titles inappropriate as summaries has been pointed out. Li et al. (Junjie Li, Haoran Li, and Chengqing Zong (2019). Towards personalized review summarization via user-aware sequence network. AAAI.) have indicated that the fact is recognized in data on review sites. Zhang et al. (Rui Zhang and Joel Tetreault (2019). This email could save your life: Introducing the task of email subject line generation. ACL.) have indicated that the fact is recognized in mail data.

Accordingly, in the present exemplary embodiment, such inappropriate data is filtered out from training data for summaries. That is, the method developed by Gregoire et al. (Francis Gregoire and Philippe Langlais (2018). Extracting parallel sentences with bidirectional recurrent neural networks to improve machine translation. COLING.) is applied to a summarization task. In this method, in a translation task, a siamese network is used to extract two sentences, which have a correspondence, from texts in two languages, and add the extracted data to existing training data, improving translation performance.

In the present exemplary embodiment, a filter model is trained by using correct pairs of text and title, which are used as “positive examples”, and incorrect pairs, which are used as “negative examples”. Negative examples, which are incorrect pairs, are obtained by changing input-output pairs, for example, through random sampling. In the present exemplary embodiment, negative examples are generated by changing input-output pairs. Thus, it is not necessary to obtain new negative examples from the outside. On reception of a pair, the trained filter model outputs a probability that the pair is correct.

Then, the trained filter model is used to filter only positive examples in the training data. In filtering, probabilities, which are output from the filter model, are compared with a threshold, and pairs, which have probabilities equal to or less than the threshold, are removed as inappropriate pairs. The filter model may determine even a positive example in the training data to be a negative example. Thus, inappropriate pairs among the pairs in the original training data are removed, and supervised data, in which only appropriate pairs remain, is obtained. The supervised data is used to train the summary model.

In the present exemplary embodiment, the negative examples, which are generated from the original training data, are used to train the filter model. The filter model is used to filter the original training data. Thus, inappropriate pairs are removed from the training data, and the learning accuracy of the summary model is improved.

The present exemplary embodiment will be described below more specifically.

### Configuration

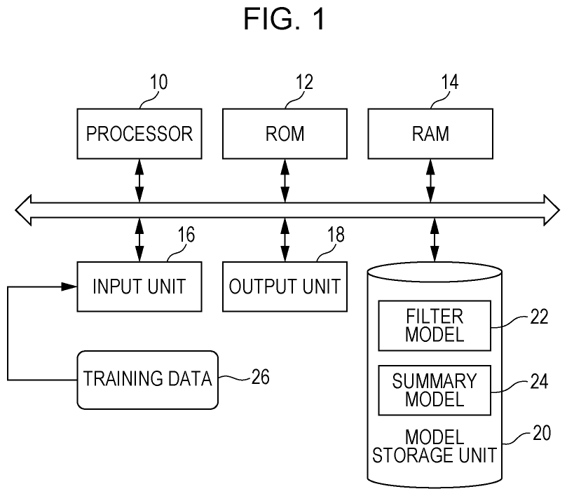

FIG. 1 is a block diagram illustrating the configuration of a training apparatus according to the present exemplary embodiment.

The training apparatus, which is formed of a computer, includes a processor 10, a read-only memory (ROM) 12, a random-access memory (RAM) 14, an input unit 16, an output unit 18, and a model storage unit 20.

The processor 10 reads out processing programs stored in the ROM 12 or other program memory, and executes the programs by using the RAM 14 as a work memory, thus implementing a filtering task and a summarization task. On the basis of received training data, the processor 10 uses the training data as positive examples, and uses incorrect pairs, which are generated from the training data, as negative examples to combine the positive examples with the negative examples, obtaining new training data. The processor 10 uses the new training data to train a filter model. The processor 10 filters the original training data by using the trained filter model, and trains a summary model by using the filtered training data as supervised data. That is, a training process performed by the processor 10 is divided broadly into the following four stages:

(1) generate negative examples from training data, and combine positive examples with the negative examples to obtain new training data;
(2) train a filter model by using the new training data;
(3) filter the original training data by using the trained filter model;
(4) train a summary model by using the filtered training data as supervised data.

The processor 10 uses the following two models:

(A) filter model;
(B) summary model.

On reception of a text, the trained summary model generates and outputs the summary of the text.

The input unit 16, which is formed of a keyboard, a communication interface, and the like, receives training data. The training data, which is text data in most cases, may be image data. In the case of image data, the optical character recognition (OCR) technique is used to convert the image data to text data. The training data includes news articles, posts on social media, posts on review sites and the like, and mail data.

The output unit 18, which is formed of a display, a communication interface, and the like, outputs a result of the summarization task performed by the processor 10, that is, a summary generated from a text.

The model storage unit 20 stores the filter model and the summary model. The processor 10 uses training data, including positive examples and negative examples, to train a filter model 22, and stores the trained filter model 22 in the model storage unit 20. The processor 10 uses the training data, which is obtained through filtering using the filter model, as supervised data to train a summary model 24, and stores the trained summary model 24 in the model storage unit 20.

In FIG. 1, the filter model 22 and the summary model 24 are stored in the same model storage unit 20. Alternatively, the filter model 22 and the summary model 24 may be stored in different storage units. In FIG. 1, the processor 10 trains both the filter model 22 and the summary model 24. Alternatively, a first processor may train the filter model 22, and a second processor, which is different from the first processor, may train the summary model 24. In other words, a computer may train the filter model 22, and a different computer may train the summary model 24. The computers may be connected to each other through a communication line.

The processor 10 refers to hardware in a broad sense. Examples of the processor include general processors (e.g., CPU: Central Processing Unit), and dedicated processors (e.g., GPU: Graphics Processing Unit, ASIC: Application Specific Integrated Circuit, FPGA: Field Programmable Gate Array, and programmable logic device). The processor is broad enough to encompass one processor or plural processors in collaboration which are located physically apart from each other but may work cooperatively.

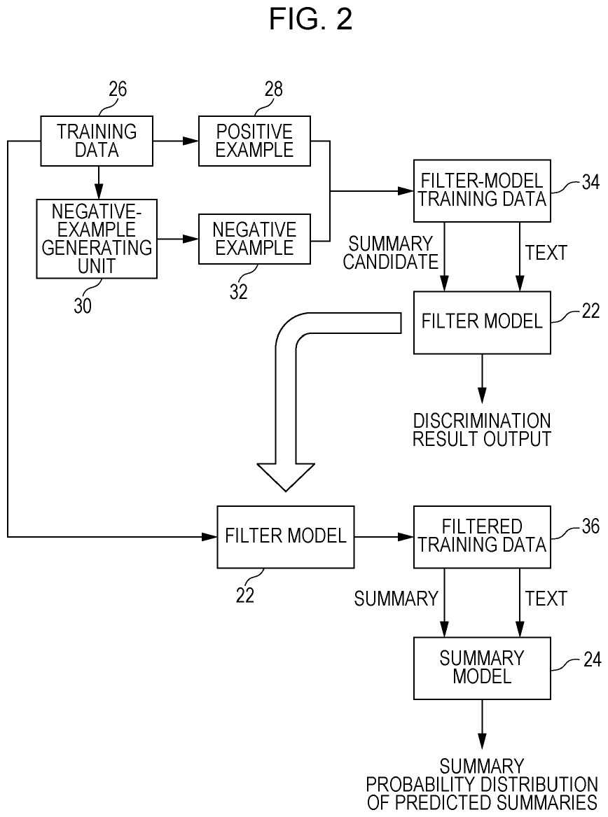

FIG. 2 functionally illustrates the training process performed by the processor 10. As described above, the models used by the processor 10 are the filter model 22 and the summary model 24.

The filter model 22 filters out (removes) inappropriate pairs of text and summary from given training data 26. To implement this function, the processor 10 uses the given training data 26 as a positive example 28, and causes a negative-example generating unit 30 to generate a negative example 32 from the training data 26. The negative example 32 indicates apparently-inappropriate pairs of text and summary, and is generated by the negative-example generating unit 30 changing combinations between text and summary. The processor 10 combines the positive example 28 with the negative example 32 to generate filter-model training data 34. The processor 10 inputs the texts and the summaries (summary candidates), which are included in the filter-model training data 34, to the filter model 22 to train the filter model 22. That is, the filter model 22 is trained to correctly discriminate the positive example 28 from the negative example 32.

Then, the processor 10 inputs the training data 26 to the trained filter model 22, and filters out inappropriate pairs of text and summary from the training data 26. Training data 36, which is obtained by filtering out inappropriate pairs, is input as supervised data to the summary model 24 to train the summary model 24.

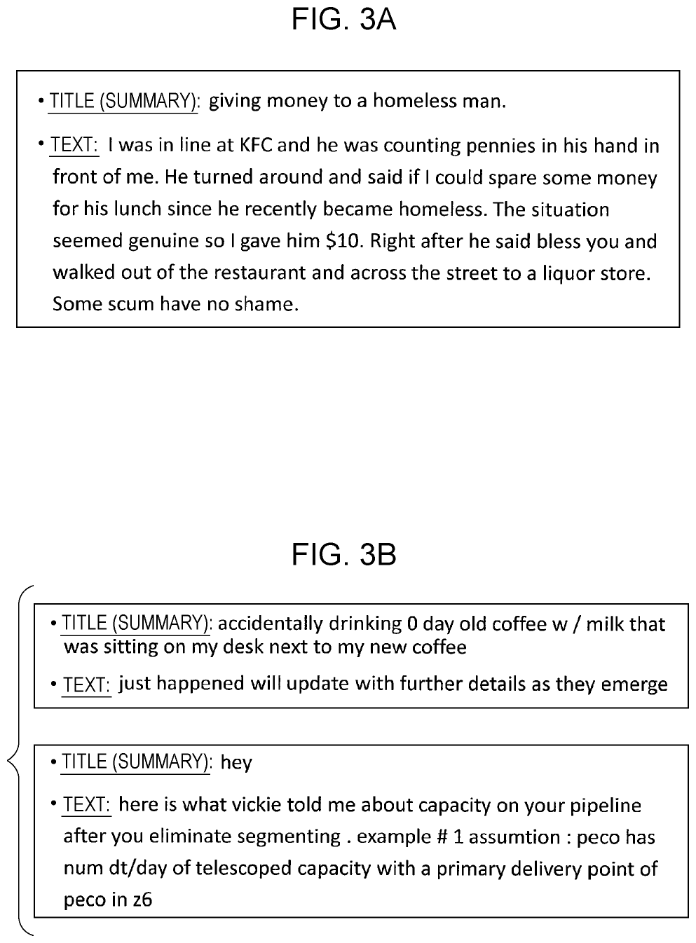

FIGS. 3A and 3B illustrate an example of the positive example 28 and an example of the negative example 32, respectively. Each of the positive example 28 and the negative example 32 is formed of pairs of text and summary. The positive example 28 is regarded as having appropriate summaries for texts. The negative example 32 has inappropriate summaries for texts.

The details of the filter model 22 and the summary model 24 are as follows.

### Filter Model

The method described by Gregoire et al. (2018) is used as the filtering method in the filter model 22. In this study, a siamese network is used to obtain sentences which form translation pairs and which are newly added to training data, thus achieving improvement in the accuracy of the translation model. Sentences in a language before translation and sentences in a language after translation are input to the model. The model is trained to discriminate correct translation pairs from incorrect translation pairs. The trained model makes prediction about a pair whose correspondence between sentences is unknown, and newly adds a positive example to the training data, thus achieving improvement in the accuracy.

In the present exemplary embodiment, the filter model 22 learns how appropriate pairs of text and summary are. The difference between the present exemplary embodiment and the related art is that, while a classification model is used to increase the training data in the related art, the negative-example generating unit 30 generates the negative example 32 from the training data 26 in the present exemplary embodiment. As long as combinations between input and output are changed, the generation process performed by the negative-example generating unit 30 is any. Pairs of text and summary in the training data 26 may be subjected to random sampling to generate new pairs, thus generating the negative example 32.

The actual pairs of text and summary in the training data 26 are used as the positive example 28, and the pairs, which are obtained through random sampling, are used as the negative example 32. Thus, the filter model 22 is trained. After training, the filter model 22 makes discrimination again only on the positive example 28 in the training data 26, that is, on the training data 26 itself. A bottom n % of data in descending order of predicted probability is removed from the training data for the summary model 24, that is, the supervised data that is input to the summary model 24.

In the modeling of the filter model 22, for example, Decomposable Attention (Ankur Parikh, Oscar Tackstrom, Dipanjan Das, and Jakob Uszkoreit (2016). A decomposable attention model for natural language inference. EMNLP.) may be used. The dimension of parameter word embedding is 300; the initial value is equivalent to a word vector in GloVe (Jeffrey Pennington, Richard Socher, and Christopher D. Manning (2014). (GloVe: Global Vectors forWord Representation. Jeffrey Pennington, Richard Socher, and Christopher D. Manning. In EMNLP 2014.) Each of the dimensions obtained after passing through an Attend Feedforward network and an Aggregation Feedforward network in the Decomposable Attention model may be 100. For optimization, for example, Adagrad may be used, and, for example, the cross entropy may be used as the loss function.

### Summary Model

In modeling of the summary model 24, for example, CopyNet (Jiatao Gu, Zhengdong Lu, Hang Li, and Victor O. K. Li (2016). Incorporating copying mechanism in sequence-to-sequence learning. ACL.) may be used. CopyNet is a model obtained by adding an encoder-decoder model with the attention mechanism to a mechanism which may generate an output sentence (summary) from unknown words included in an input sentence (text). For parameters, as in the filter model 22, the dimension of word embedding may be 300; GloVe (Pennington et al. (2014)) may be employed for the initial value. The hidden layer size may be, for example, 256. The size of beam search may be 8; Adam is used for optimization; the cross entropy may be used for the loss function.

### Flowchart

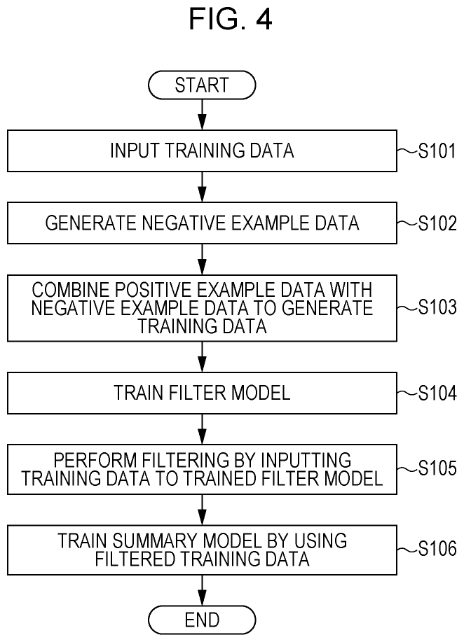

FIG. 4 illustrates a flowchart of a process according to the present exemplary embodiment.

Multiple pieces of training data 26 formed of pairs of text and summary are obtained, and are input to the input unit 16 (S101).

In response to input of the training data 26, the processor 10 generates the negative example 32 from the training data 26 (S102). Specifically, the pairs of text and summary in the training data 26 are subjected to random sampling, and new pairs are generated by combining the texts with the summaries which are obtained through sampling. The new pairs may be generated by shuffling pairs of text and summary in the training data 26. For example, assume that pairs (positive example 28) of text and summary in the training data 26 are as follows:

### (C1, S1), (C2, S2), (C3, S3), (C4, S4), . . . .

These pairs are shuffled to obtain, for example, the following pairs which form the negative example 32:

### (C1, S2), (C2, S5), (C3, S1), (C4, S10), . . . .

After generation of the negative example 32, the processor 10 combines the data of the positive example 28 with the data of the negative example 32 to generate new training data (S103). The processor 10 inputs the new training data to the filter model 22 to train the filter model (S104). The filter model 22 learns to discriminate pairs of the positive example 28 from pairs of the negative example 32. The filter model 22 outputs a probability of a positive example as a discrimination probability (predicted probability).

After training the filter model 22, the processor 10 inputs the training data 26 to the trained filter model 22, and filters the training data 26 (S105). That is, in S102, the negative example 32 is generated. In S103, the positive example 28 is combined with the negative example 32 to generate the new training data. In S105, to filter the original training data 26, the original training data 26 itself, that is, only the positive example 28 is input to the filter model 22. The filter model 22 outputs a predicted probability of a positive example for each piece of the input positive example 28. The filter model 22 compares the output predicted probabilities with the preset threshold to remove positive examples whose probabilities are equal to or less than the threshold. For example, the threshold is set to 10%, and the pieces of the positive example 28, whose predicted probabilities are 10% or less, are removed as inappropriate pairs. The threshold for filtering may be adjusted as appropriate in accordance with the purpose.

As described above, after the trained filter model 22 is used to filter the training data 26, the filtered training data 26 is used as supervised data to train the summary model 24 so that, upon input of a text, its summary is output (S106).

### Embodiment Example

An embodiment example uses subjects in Enron mail data (Zhang et al. (2019)) and titles of Reddit TIFU data (Byeongchang Kim, Hyunwoo Kim, and Gunhee Kim (2019). Abstractive summarization of Reddit posts with multi-level memory networks. NAACL.) Enron dataset and Enron mail data are originally mail datasets of Enron Corporation which were published 2004. These datasets were maintained for a title generation task, and the resulting dataset was released to the public by Zhang et al. (2019). The dataset contains 14,436 pieces of training data, 1,906 pieces of test data, and 1,906 pieces of text data. The mail subjects in the training data are the same as those in the datasets published 2004. The test data and the text data are newly generated manually. This is because many of the subjects included in the original mail data do not reflect their content and are inappropriate. The mail texts and the subjects are tokenized into words by using nitk.

The Reddit TIFU dataset is obtained by collecting posts in TIFU (Today I fucked up) which is one of subreddits in Reddit (Kim et al. (2019)). In the dataset, a title is attached to each post, and the title is regarded as a summary of the posted text. The pairs of posted text and title, whose total number is 79,015, are divided into training data, test data, and text data in a ratio of 9:0.5:0.5. The numbers of data pieces for data types are 71,113, 3,951, and 3,951. The texts (posted texts and titles) included in the published dataset are tokenized into words in advance by using spacy. Thus, the tokenized data is used.

As the filtering method in the filter model 22, the method described by Gregoire et al. (2018) is used.

In the modeling of the filter model 22, Decomposable Attention (Parikh et al. (2016)) is used. The dimension of parameter word embedding is 300; the initial value is equivalent to a word vector in GloVe4. Each of the dimensions obtained after passing through an Attend Feedforward network and an Aggregation Feedforward network in the Decomposable Attention model is 100. Adagrad is used for optimization. The cross entropy is used for the loss function.

In the modeling of the summary model 24, CopyNet (Gu et al. (2016)) is used. As in the filter model 22, the dimension of parameter word embedding is 300; GloVe (Pennington et al. (2014)) is used for the initial value. The hidden layer size is 256; the size of beam search is 8; Adam is used for optimization; the cross entropy is used for the loss function.

In the configuration described above, the accuracy in a first case is compared with that in a second case. In the first case, the filter model 22 removes bottoms of 5%, 10%, 15%, and 20% of pieces of data in descending order of the predicted probability, and the summary model 24 is trained. In the second case, 5%, 10%, 15%, and 20% of pieces of data are removed randomly, and the summary model 24 is trained. For evaluation of the accuracy of the summary model 24, ROUGE-1-F (R1), ROUGE-2-F (R2), and ROUGE-L-F (RL) are used. To prevent the results from being influenced from the randomness in optimization, in parameter initialization, and in filtering, the summary model 24 is trained ten times, and the average of the accuracies is used. The epoch count is 5. An epoch model, whose ROUGE-1-F value in the test data is maximum, is used in the test.

### Training Results

### Training Results of the Filter Model 22

The trained filter model 22 has the following accuracies (F1 values) at which pairs of title and text are correctly determined:

TIFU title data: 0.930;
Enron subject data: 0.800.
The reason why the accuracy for TIFU title data is higher is that TIFU titles have longer summary lengths than those of Enron subjects and that the fact that the content of the Reddit posts themselves is more diverse than that of the mail data leads to easy prediction of the relationship with text.

For Enron subject data, the thresholds of the predicted probability values of the filter model 22 in filtering (5%, 10%, 15%, and 20% of all pieces of data) were as follows:

5%: 0.215;
10%: 0.307;
15%: 0.390;
20%: 0.467.
For Reddit title data, the thresholds were as follows:
5%: 0.246;
10%: 0.424;
15%: 0.584;
20%: 0.717.
The reason why the threshold values are higher is that data, which is to be filtered, is positive examples in the training data 26 for the filter model 22.

### Training Results of the Summary Model

Tables 1 and 2 describe training results of the summary model 24 after the filtering. Table 1 describes results for TIFU title, and Table 2 describes results for Enron subject.

TABLE 1

| | Evaluation | | | | | |
|---|---|---|---|---|---|---|
| | index | 0% | 5% | 10% | 15% | 20% |
| embodiment | R1 | 0.618 | 0.167 | 0.167 | 0.170 | 0.171 |
| example | | | | | | |
| random | R1 | 0.618 | 0.167 | 0.167 | 0.167 | 0.164 |
| filtering | | | | | | |
| embodiment | R2 | 0.064 | 0.064 | 0.063 | 0.064 | 0.065 |
| example | | | | | | |
| random | R2 | 0.064 | 0.064 | 0.063 | 0.064 | 0.063 |
| filtering | | | | | | |
| embodiment | RL | 0.084 | 0.082 | 0.083 | 0.084 | 0.085 |
| example | | | | | | |
| random | RL | 0.084 | 0.082 | 0.083 | 0.082 | 0.081 |
| filtering | | | | | | |

TABLE 2

| | Evaluation | | | | | |
|---|---|---|---|---|---|---|
| | index | 0% | 5% | 10% | 15% | 20% |
| embodiment | R1 | 0.241 | 0.241 | 0.239 | 0.247 | 0.242 |
| example | | | | | | |
| random | R1 | 0.241 | 0.240 | 0.241 | 0.243 | 0.240 |
| filtering | | | | | | |
| embodiment | R2 | 0.096 | 0.098 | 0.097 | 0.098 | 0.094 |
| example | | | | | | |
| random | R2 | 0.096 | 0.096 | 0.097 | 0.095 | 0.090 |
| filtering | | | | | | |
| embodiment | RL | 0.127 | 0.126 | 0.124 | 0.130 | 0.126 |
| example | | | | | | |
| random | RL | 0.127 | 0.126 | 0.126 | 0.128 | 0.128 |
| filtering | | | | | | |

The tables show that, in the case of TIFU title data, as the amount of training data, which is removed through filtering, increases, the results of random filtering degrades; in contrast, in the embodiment example, the accuracy increases. In Enron subject data, in the case of a removal rate of 15%, the accuracy of the embodiment example exceeds that of random filtering, while the accuracies at the other removal rates are in almost the same levels.

Table 3 describes concrete examples of filtered data with their predicted probabilities.

TABLE 3

| | | | Predicted |
|---|---|---|---|
| Data | Title | Text | probability |
| TIFU | Trimming my | I have strong beard, it's | 1.000 |
| title | beard; a | been growing for 10 months. | |
| | tale of woe | start trimming accidentally | |
| | | trim off too much | |
| | | compensate. Depression | |
| | | kicks in. | |
| TIFU | Telling my | They just looked at me | 0.004 |
| title | students a | weirdly and thought I was | |
| | PERSON | some kind of horrible | |
| | PERSON joke | person now I guess I should | |
| | | just teach what is written | |
| | | in the textbook | |
| Enron | Offline NDA | As an fyi, from time to | 1.000 |
| subject | form | time I will be preparing | |
| | | NDAs for the networks team | |
| | | headed by marks. PERSON | |
| | | working with PERSON on. | |
| | | Project offline has evolved | |
| | | a form of NDA and added a | |
| | | non-solicitation clause and | |
| | | a residuals clause. | |
| | | (omitting the rest) | |
| Enron | Lexis | PERSON, although this | 0.009 |
| subject | luncheon- | presentation is for the | |
| | Wed. 9/22 | legal dept. I thought | |
| | 11:30-1:00 | maybe if you have a | |
| | eb46c1 | representative from your | |
| | | group there it might be | |
| | | helpful. Do you have | |
| | | someone, like PERSON | |
| | | PERSON, that you would like | |
| | | to attend? Let me know, and | |
| | | I'll get their name added | |
| | | to the list. | |

In Table 3, for example, the pair of a title, “Trimming my beard; a tale of woe”, and a text, “I have strong beard, it's been growing for 10 months. start trimming accidentally trim off too much compensate. Depression kicks in”, is output as having a predicted probability of 1.000. The pair of a title, “Telling my students a PERSON PERSON joke”, and a text, “They just looked at me weirdly and thought I was some kind of horrible person now I guess I should just teach what is written in the textbook”, is output as having a predicted probability of 0.004. The pair having a predicted probability of 0.004 is removed as an inappropriate pair. The “person” is a string with which a specific person name is replaced.

In many pieces of filtered data, a summary was difficult to be predicted from its text. On social media and mail, what a text describes may be different from what its title describes. Especially in TIFU data, as in the example of the table, a title continues to its text. Thus, there were many examples in which their titles are not included in their texts. In contrast, the title of a pair having a high predicted probability reflected the content of its text.

As described above, in Enron dataset, the accuracies are almost equivalent to those for random filtering. In contrast, TIFU dataset has higher accuracies than those of random filtering.

### First Modified Example

In the present exemplary embodiment, by using the trained summary model 24, a text is input, and its summary is output. An error or the accuracy at that time may be fed back to the filter model 22. The filter model 22 may be subjected to reinforced training. Thus, the filtering accuracy of the filter model 22 may be further improved.

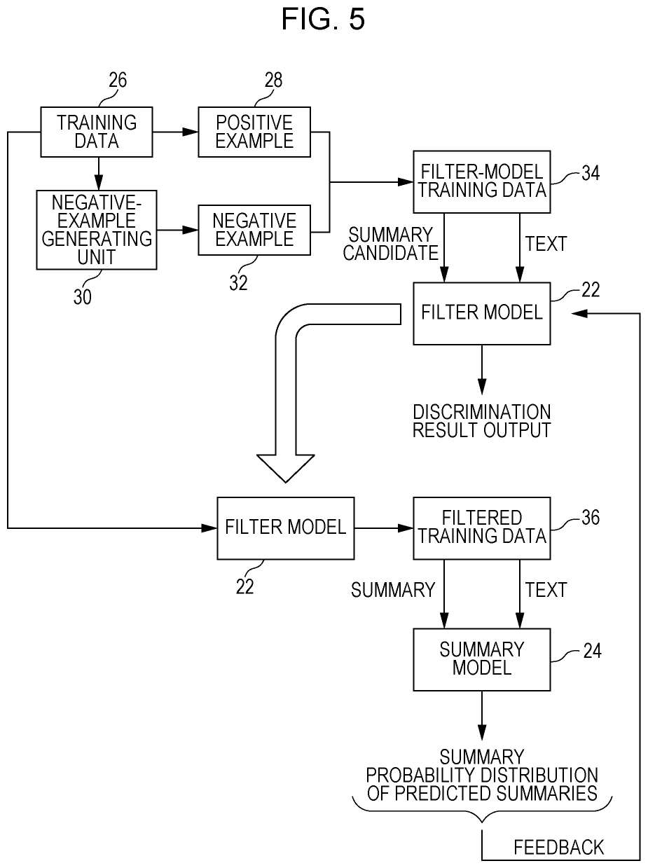

FIG. 5 functionally illustrates a training process performed by the processor 10 in this case. The difference between FIG. 5 and FIG. 2 is that an output error from the summary model 24, that is, the probability distribution of predicted summaries is fed back to the filter model 22 for retraining. Specifically, reinforced training is performed to improve the accuracy of the summary model 24.

### Second Modified Example

In the present exemplary embodiment, the trained filter model 22 compares predicted probabilities, which are output, with a threshold. Pairs having predicted probabilities equal to or less than the threshold are removed as inappropriate pairs. Alternatively, the entropy may be calculated on the basis of a predicted probability. The calculated entropy may be used to remove inappropriate pairs.

Specifically, text is represented by sₖ, and summary is represented by tₖ. A pair of sₖ and tₖ is assumed to be correct.

The discrimination probability (predicted probability), which indicates whether or not the pair of sₖ and tₖ is correct and which is calculated by the filter model 22, is obtained as follows.

p(c|sₖ,tₖ)

A set of N texts, which are other than sₖ and are obtained by a certain method σ, is expressed as follows.

S_(N/k)=[s_(i)|i=σ(1) . . . σ(N)]

A set of N summaries, which are other than tₖ and are obtained by a certain method τ, is expressed as follows.

T_(N/K)={t_i|i=τ(1) . . . τ(N)}

However, the following condition is satisfied.

∀ii≠k

The certain methods are, for example, based on random sampling. Entropy(sₖ) for a text, and Entropy(tₖ) for a summary text are calculated by using the following expressions.

$$Entropy ( {t}_{k} ) = - p ( c \vert {s}_{k} , {t}_{k} ) log p ( c \vert {s}_{k} , {t}_{k} ) - {\sum }_{{s}_{i} ∈ {S}_{N / k}} p ( c \vert {s}_{i} , {t}_{k} ) log p ( c \vert {s}_{i} , {t}_{k} )$$

$$Entropy ( {s}_{k} ) = - p ( c \vert {s}_{k} , {t}_{k} ) log p ( c \vert {s}_{k} , {t}_{k} ) - {\sum }_{{t}_{i} ∈ {T}_{N / k}} p ( c \vert {s}_{k} , {t}_{i} ) log p ( c \vert {s}_{k} , {t}_{i} )$$

Pairs of summary and text, for which these entropy values satisfy a certain condition, may be removed from the training data 26.

### Third Modified Example

In the present exemplary embodiment, random sampling and shuffling are described as an exemplary process performed by the negative-example generating unit 30. Alternatively, the degree of similarity between sentences may be calculated. On the basis of the degree of similarity, the negative example 32 may be generated so that the degree of similarity is equal to or larger than a threshold. The degree of similarity between sentences may be calculated by using a range index, such as Levenshtein distance, Humming distance, or Cosine distance. Levenshtein distance is a type of distance indicating how much two strings are different. Levenshtein distance is defined as the minimum number of procedures necessary to change a first string into a second string through insertion, deletion, and replacement of one character. Hamming distance indicates the number of character pairs, which satisfy the following condition, in two strings having the same string length: a character pair are located at the corresponding positions, and one character in the pair is different from the other character. Hamming distance is obtained by measuring the number of replacements necessary to change a certain string into a different string.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A training apparatus comprising:
an input unit that inputs a plurality of pairs of input and output;
a processor; and
an output unit,
wherein the processor is configured to, through execution of a program,
generate the plurality of pairs of input and output as positive examples, and generate, as negative examples, pairs in which the combinations of input and output are changed,
train a filter model by using the positive examples and the negative examples, and
use the filter model to perform filtering by removing incorrect pairs from the plurality of pairs of input and output.

2. The training apparatus according to claim 1,
wherein the processor is further configured to
train a model by using the filtered pairs of input and output, the model obtaining the output in response to the input.

3. The training apparatus according to claim 1,
wherein the processor is configured to
generate the negative examples by switching the plurality of pairs of input and output randomly.

4. The training apparatus according to claim 2,
wherein the processor is configured to
generate the negative examples by switching the plurality of pairs of input and output randomly.

5. The training apparatus according to claim 1,
wherein the processor is configured to
generate the negative examples on a basis of a degree of similarity between the input and the output.

6. The training apparatus according to claim 2,
wherein the processor is configured to
generate the negative examples on a basis of a degree of similarity between the input and the output.

7. The training apparatus according to claim 2,
wherein the processor is configured to
subject the filter model to reinforced training on a basis of an output result from the trained model obtaining the output in response to the input.

8. The training apparatus according to claim 1,
wherein the filter model uses a discrimination probability indicating whether or not a pair of input and output is correct.

9. The training apparatus according to claim 2,
wherein the filter model uses a discrimination probability indicating whether or not a pair of input and output is correct.

10. The training apparatus according to claim 3,
wherein the filter model uses a discrimination probability indicating whether or not a pair of input and output is correct.

11. The training apparatus according to claim 4,
wherein the filter model uses a discrimination probability indicating whether or not a pair of input and output is correct.

12. The training apparatus according to claim 5,
wherein the filter model uses a discrimination probability indicating whether or not a pair of input and output is correct.

13. The training apparatus according to claim 6,
wherein the filter model uses a discrimination probability indicating whether or not a pair of input and output is correct.

14. The training apparatus according to claim 7,
wherein the filter model uses a discrimination probability indicating whether or not a pair of input and output is correct.

15. The training apparatus according to claim 1,
wherein the filter model uses entropy calculated from a discrimination probability indicating whether or not a pair of input and output is correct.

16. The training apparatus according to claim 2,
wherein the filter model uses entropy calculated from a discrimination probability indicating whether or not a pair of input and output is correct.

17. The training apparatus according to claim 3,
wherein the filter model uses entropy calculated from a discrimination probability indicating whether or not a pair of input and output is correct.

18. The training apparatus according to claim 1,
wherein the input is text data and the output is summary data of the text data.

19. The training apparatus according to claim 1,
wherein the input is original-text data and the output is translation data of the original-text data.

20. A non-transitory computer readable medium storing a program causing a computer to execute a process comprising:
inputting a plurality of pairs of input and output;
generating the plurality of pairs of input and output as positive examples, and generating, as negative examples, pairs in which the combinations of input and output are changed;
training a filter model by using the positive examples and the negative examples; and
using the filter model to perform filtering by removing incorrect pairs from the plurality of pairs of input and output.
